(19) United States
(12) Patent Application Publication
(10) Pub. No.: US 2026/0106948 A1
(43) Pub. Date: Apr. 16, 2026

(54) Image Processing Method and Video Processor Thereof

(71) Applicant: NOVATEK Microelectronics Corp., Hsin-Chu (TW)

(72) Inventors: Yi-Hung Huang, Hsinchu County (TW); Chih Chang, Hsinchu City (TW); Chia-Shiou Yang, Hsinchu County (TW); Tsung-Heng Lin, Hsinchu City (TW); Chun-Wei Chen, Taipei City (TW); Chih-Chia Kuo, Hsinchu City (TW)

(73) Assignee: NOVATEK Microelectronics Corp., Hsin-Chu (TW)

(21) Appl. No.: 19/358,456

(22) Filed: Oct. 15, 2025

(30) Foreign Application Priority Data
Oct. 16, 2024 (TW) 113139243

(51) Int. Cl. H04N 7/01; G06T 1/20; G11B 27/34

(52) U.S. Cl. CPC H04N 7/0135; G06T 1/20; G11B 27/34

(57) ABSTRACT

An image processing method for a video processor includes receiving a first input frame at a first time instant, receiving a second input frame at a second time instant, and creating an interpolated frame. When no input frame is received at a third time instant, the interpolated frame is generated using extrapolation according to the first and second input frames. When a third input frame is received at the third time instant, the interpolated frame is generated using interpolation according to the second and third input frames. The video playback smoothness can be improved by dynamically switching between extrapolation and interpolation.

### BACKGROUND OF THE INVENTION

### 1. Field of the Invention

The present invention relates to an image processing method and a video processor thereof, and more particularly, to an image processing method and a video processor thereof capable of improving visual effects.

### 2. Description of the Prior Art

In image processing technology, motion estimation and motion compensation (MEMC) is a technology using frame interpolation/extrapolation. This technology identifies a motion vector (MV) of a moving object between two consecutive image frames and inserts an interpolated frame between them, thereby enabling a series of image frames to be displayed at a higher frame rate. However, when input images are unstable, the existing methods fail to output images smoothly.

### SUMMARY OF THE INVENTION

An embodiment of the present application discloses an image processing method, for a video processor, comprising receiving a first input frame at a first time instant; receiving a second input frame at a second time instant; and creating an interpolated frame; wherein when no input frame is received at a third time instant, the interpolated frame is generated using extrapolation according to the first and second input frames; wherein when a third input frame is received at the third time instant, the interpolated frame is generated using interpolation according to the second and third input frames.

An embodiment of the present application discloses a video processor, comprising an input terminal; and an output terminal; wherein the video processor is configured to receiving a first input frame at a first time instant; receiving a second input frame at a second time instant; and creating an interpolated frame; wherein when no input frame is received at a third time instant, the interpolated frame is generated using extrapolation according to the first and second input frames; wherein when a third input frame is received at the third time instant, the interpolated frame is generated using interpolation according to the second and third input frames.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an embodiment of the present invention.

FIG. 2 to FIG. 5 illustrate the frame rate conversion of converting a source video of 60 Hz into 120 Hz for display according to an embodiment of the present invention.

FIG. 6 is a schematic diagram illustrating the relationship among phases, the previous frame, an interpolated frame using interpolation, the current frame, or an interpolated frame using extrapolation according to an embodiment of the present invention.

FIG. 7 is a schematic diagram of an electronic system according to an embodiment of the present invention.

### DETAILED DESCRIPTION

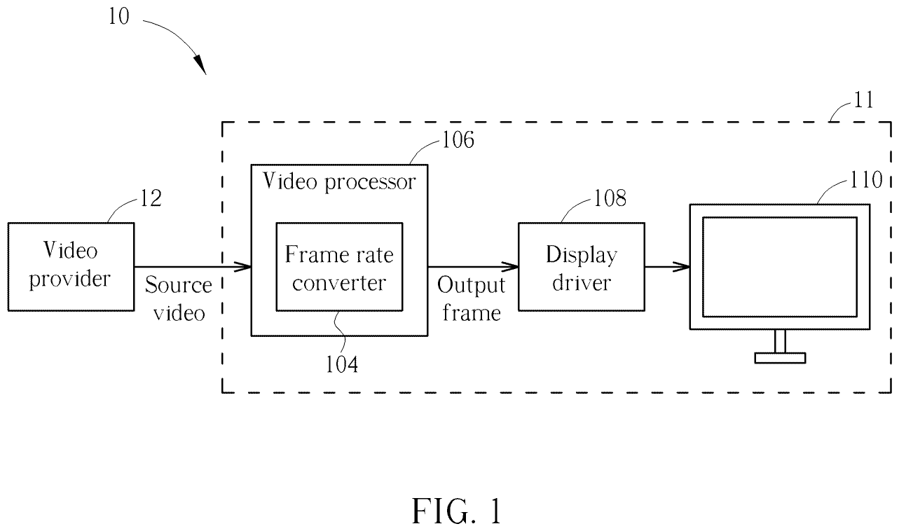

FIG. 1 is a schematic diagram of an electronic system 10 according to an embodiment of the present invention. In the electronic system 10, a display system 11 may receive and display a source video provided by a video provider 12 (e.g., an application processor (AP) or an application program (APP)). The display system 11 includes a video processor 106, a display driver 108, and a display panel 110.

The video processor 106 may perform frame rate conversion (FRC) to produce smoother output frames. Specifically, based on considerations such as power, the frame rate of the source video may differ from the frame rate desired to be displayed on the display panel 110. To address this, a frame rate converter 104 of the video processor 106 may convert the source video with a lower frame rate and generate a series of output frames with a higher frame rate, such that the display panel 110 may render video corresponding to the higher frame rate.

For example, if the frame rate of the input image rate is 30 Hz, the frame rate converter 104 may convert two received input frames (e.g., A and B) into four output frames of 60 Hz—namely A, a first interpolated frame, B, and a second interpolated frame. In this manner, the frame rate converter 104 may convert input images with the frame rate of 30 Hz into output images with the frame rate of 60 Hz. In one embodiment, the first interpolated frame may be generated through interpolation between the two input frames A and B, and the second interpolated frame may be generated through interpolation between the input frame B and the subsequent input frame. In another embodiment, the second interpolated frame may be generated through extrapolation according to the input frames A and B. In yet another embodiment, the frame rate converter 104 may convert the received two input frames A and B into four output frames A, A, B, and B.

However, the video provider 12 may not be able to input a certain image frame to the video processor 106 or fail to do so in time, resulting in a delay or a frame drop. For example, when a mobile phone executes a game application, the front-end video provider 12 may become overloaded or overheated, causing the rendering time to exceed expectations. As a result, although the video provider 12 is expected to deliver 60 frames of images per second (i.e., the frame rate is 60 frames per second (FPS)) to the display driver 108 or video processor 106, it may only provide 55 frames of images per second in practice. This leads to incorrect image display by the display driver 108 and a degraded user experience.

To improve user experience, the frame drop issue may be solved through the frame rate converter 104. In one embodiment, the frame rate converter 104 may add at least one duplicate frame, which serve as interpolated frame(s), for a previously received image frame (referred to as the previous frame) and a currently received image frame (referred to as the current frame) provided by the video provider 12.

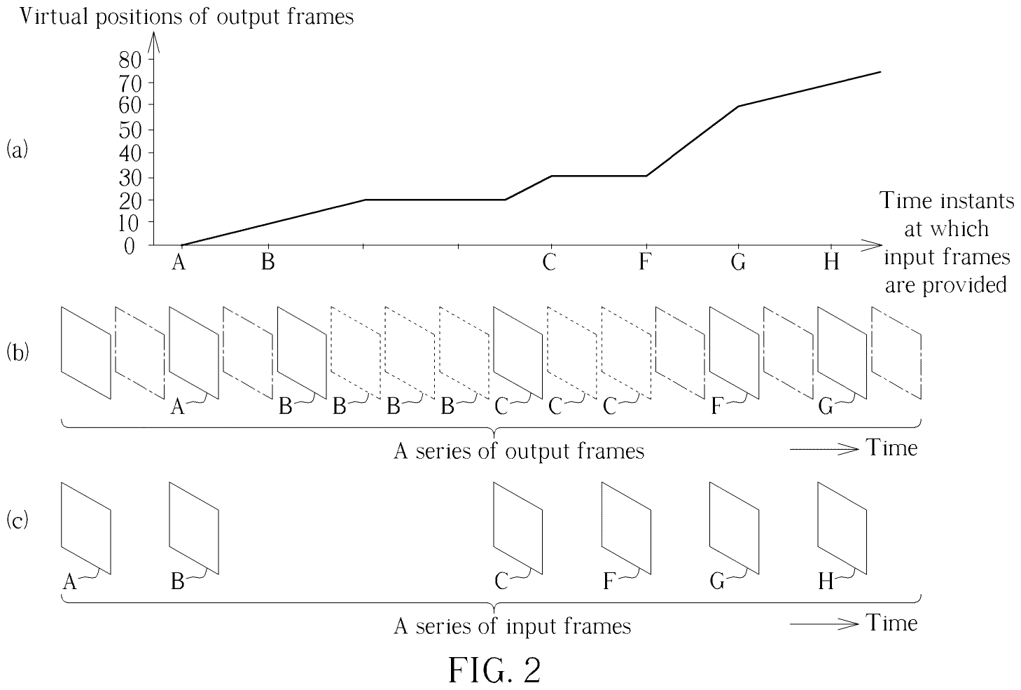

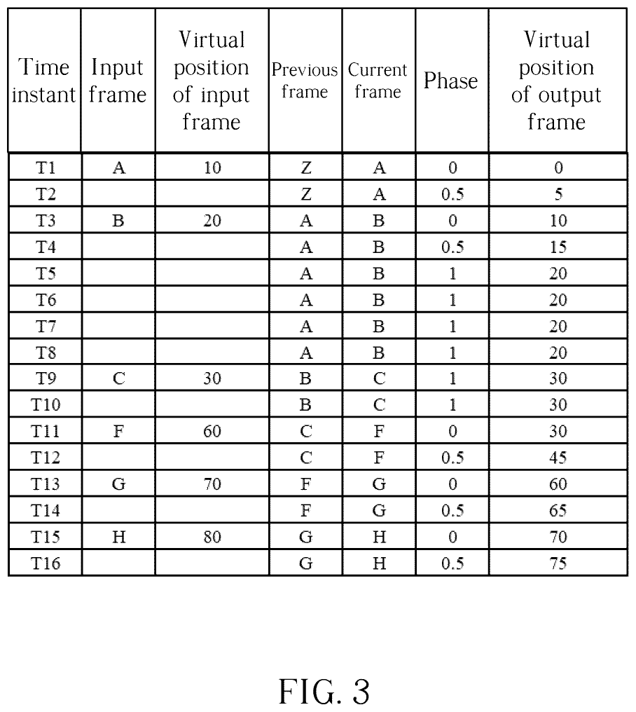

Please refer to FIG. 2 and FIG. 3, which respectively illustrate the frame rate conversion of converting the source video of 60 Hz into 120 Hz for display according to an embodiment of the present invention. According to FIG. 3, the video provider 12 does not provide an input frame C at a time instant T5, meaning that a delay or a frame drop occurs. However, the video processor 106 still needs to output an image frame corresponding to the time instant T5 in order to maintain the target frame rate. Therefore, after outputting an image frame B, the video processor 106 continues to output the image frame B (that is, after time instants T5 to T8, four duplicate frames B are added corresponding to the time instants T5-T8) to compensate for the dropped frame(s). Until the video processor 106 receives the input frame C at a time instant T9, the video processor 106 can output the image frame C different from the image frame B (for example, after time instants T9 to T11, three duplicate frames C are inserted corresponding to the time instants T9-T11). Since the video processor 106 continuously sends multiple duplicate frames (also referred to as look-alike frames) over a period of time, the output of the video processor 106 appears less smooth as shown by a broken line in FIG. 2(a).

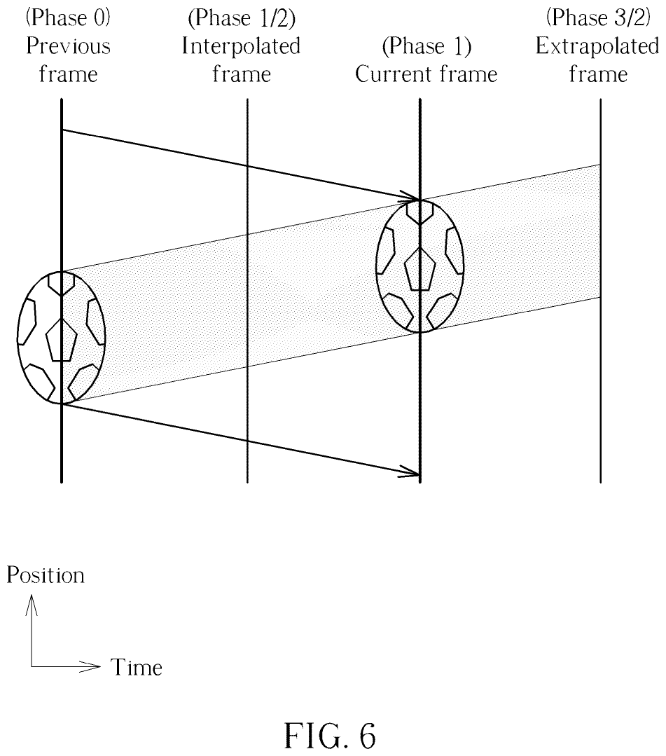

To improve output smoothness, the frame rate converter 104 may generate an interpolated frame based on the current frame and the previous frame using information of phase(s). For example, any given frame may include different objects (e.g., a soccer ball shown in FIG. 6, other objects, or virtual objects). Based on the positional information of two most recently received image frames (i.e., the current frame and the previous frame) corresponding to an object, a motion vector can be calculated. Next, based on a phase and the motion vector, the positional information corresponding to the object at a certain time instant is calculated. With this arithmetic logic, an interpolated frame for that time instant may be created to enhance visual smoothness.

In other words, an arbitrary image block of the interpolated frame is generated based on a block of the current frame and a corresponding block of the previous frame using a phase. The block of the current frame and the corresponding block of the previous frame correspond to the same object (or the same virtual object), and the positional difference between the position (or virtual position) of the block of the current frame and the (virtual) position of the corresponding block of the previous frame may form a motion vector. The position corresponding to the object in the interpolated frame is then inferred from the motion vector and a phase. For example, an arbitrary (virtual) object of the interpolated frame may satisfy x=a+(b−a)×p=(1−p)×a+p×b, where a, b, and x represent the coordinates (or virtual positions) corresponding to the (virtual) object in a previous frame A, a current frame B, and an interpolated frame X, respectively, b-a represents a motion vector, and p represents a phase.

Please note that a virtual position may not be a specific position in a frame but a parameter about the position for an algorithm. Furthermore, a virtual position may be simulated using a virtual moving object. Therefore, the position of a real object (e.g., the soccer ball shown in FIG. 6) may be represented using X and Y coordinates, whereas the virtual position of a virtual object may be represented using a numerical value.

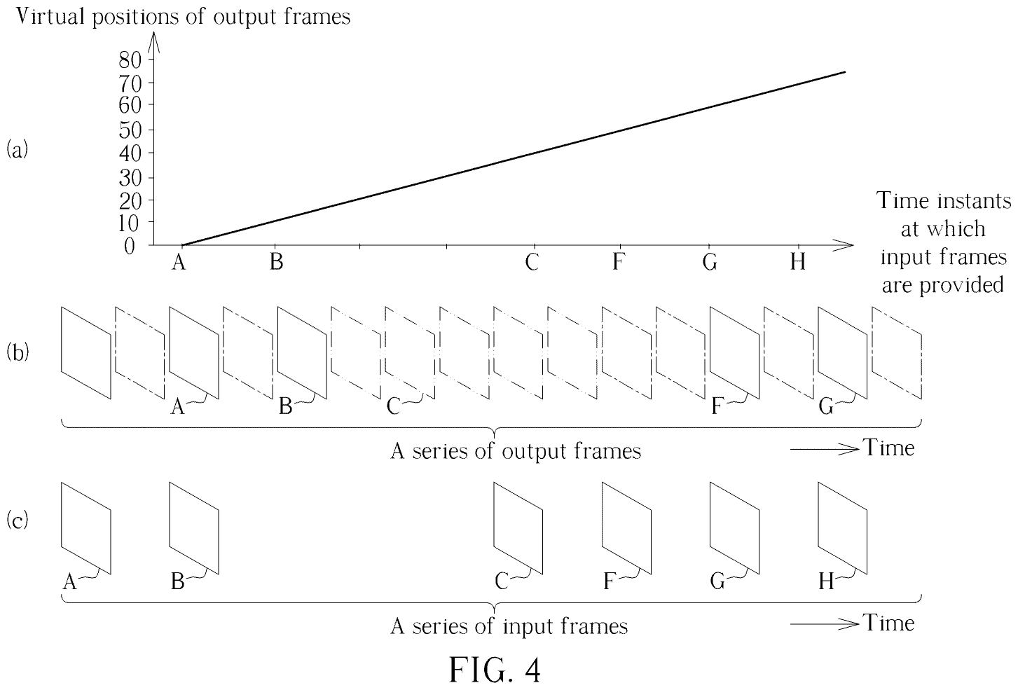

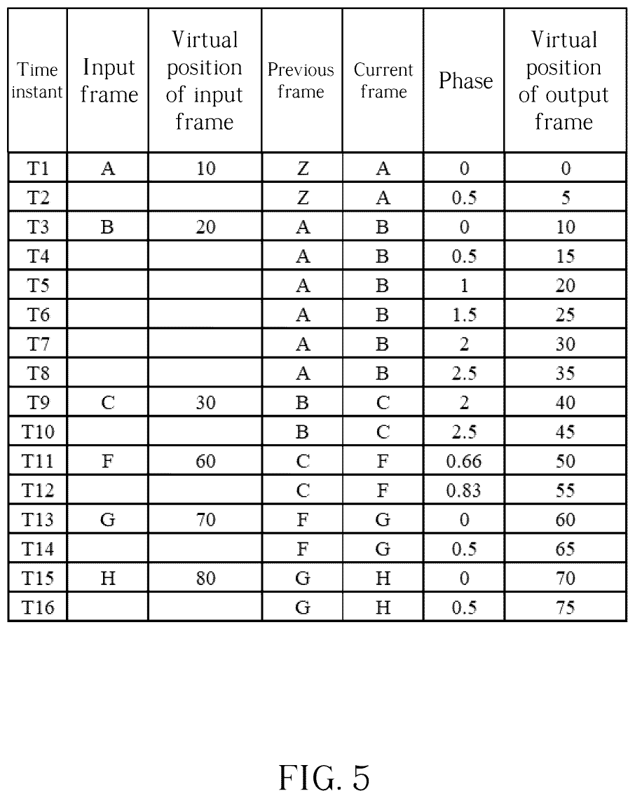

In one embodiment, a phase may be calculated using the input frame rate and the output frame rate. For example, please refer to FIG. 4 and FIG. 5. At time instants T1 and T2 in FIG. 5, the video processor 106 receives one input frame A and outputs two output frames. The input frame rate and the output frame rate may be 60 and 120 Hz, respectively. A phase step may be defined as the input frame rate divided by the output frame rate (i.e., 60/120=0.5). When the video processor 106 does not receive any input frame at the time instant T2, the phase corresponding to the time instant T2 is calculated by adding one phase step to the phase corresponding to the time instant T1. Therefore, the phases corresponding to the time instants T1 and T2 may be 0 and 0.5, respectively.

Furthermore, at a time instant T3 in FIG. 5, the video processor 106 receives an input frame B. The phase corresponding to the time instant T3 is calculated by subtracting one phase step from the phase corresponding to the time instant T2, making the phase corresponding to the time instant T3 equal to 0. At time instants T4 to T8 in FIG. 5, the video provider 12 does not provide any input frame, so the phases corresponding to the time instants T4-T8 are calculated by adding one phase step to the phases corresponding to the previous time instants T3-T7, respectively. That is, the phases corresponding to the time instants T4-T8 are 0.5, 1, 1.5, 2, and 2.5, respectively.

Similarly, at a time instant T9 in FIG. 5, the video processor 10 receives an input frame from the video provider 12, and the video processor 10 determines the received input frame as the frame C according to the times tamp thereof. The video processor 106 then determines whether the received input frame C is the expected one for display corresponding to the time instant T9. Although the video processor 106 may determine that the expected input frame corresponding to the time instant T9 is supposed to be an image frame E, the phase (i.e., 2) corresponding to the time instant T9 still decreases because a new input frame is received. In this embodiment, the output frame at T9 is generated according to frames B and C by extrapolation method. Additionally, the phase corresponding to the next time instant T10 increases. For example, the phase (i.e., 2 or 0) corresponding to the time instant T9 or T15 is calculated by subtracting 0.5 from the phase (i.e., 2.5 or 0.5) corresponding to the previous time instant T8 or T14, respectively. The phase (i.e., 2.5, 0.5, or 0.5) corresponding to the time instant T10, T14, or T16 is calculated by adding 0.5 to the phase corresponding to the previous time instant T9, T13, or T15.

In another embodiment, when the video processor 10 determines the received input frame is frame E according to the time stamp thereof. The virtual position of previous received frame B is 20, the virtual position of the current received frame E is 50, and the position of output frame at T9 is 50. According to the following equation, the phase is 0.66.

$$( PrevPosi + ( CurPost - PrevPosi ) * ph = Target position of current output )$$

$$At time T 9 :$$

$$PrevPosi = Posi ( B ) = 20$$

$$CurrPosu = Posi ( E ) = 50$$

$$Target position of T 9 = 40$$

$$= > ph = 0.66 = > interpolation mode$$

The phase is 0.66. The output frame at T9 is generated according to frames B and E by interpolation method.

In one embodiment, a phase may be appropriately adjusted according to the time stamp of an input frame. For example, in FIG. 5, the time instant at which the video processor 106 receives an input frame F may not match the expected time instant (for example, the difference between the time stamp of the input frame C and the time stamp of the input frame F may not be an integer multiple of the reciprocal of the input frame rate). Therefore, the phase may be adjusted according to the temporal difference between the temporal information for the input frame F and the temporal information for the input frame that was originally expected to be displayed. As a result, the phases corresponding to the time instants T11 and T12 are 0.66 and 0.83 respectively. For example, in FIG. 5, if the video processor 106 receives an input frame G at a time instant that matches the expected time instant (for example, the difference between the time stamp of the input frame C and the time stamp of the input frame G is equal to or less than an integer multiple of the reciprocal of the input frame rate), there is no phase difference, such that the phase corresponding to a time instant T13 is 0.

In one embodiment, when a phase (e.g., the phase corresponding to the time instant T9) is greater than 1, the video processor 106 may generate an interpolated frame using extrapolation based on the two most recently received input frames. When a phase (e.g., the phase corresponding to the time instant T5) is equal to 1, an interpolated frame generated by the video processor 106 is a duplicate frame similar to the current frame. When a phase (e.g., the phase corresponding to the time instant T12) is less than 1, the video processor 106 may generate an interpolated frame using interpolation based on the two most recently received input frames. When a phase is equal to 0, an interpolated frame generated by the video processor 106 is a duplicate frame similar to the previous frame. In other words, the video processor 106 is able to switch at least between interpolation and extrapolation to generate an interpolated frame.

As set forth above, the video provider 12 may transmit images normally, experience jitter, or drop frames. In response, the frame rate converter 104 may accordingly adopt the interpolation mode or the extrapolation mode to create interpolated frame(s). For example, when the video provider 12 sends image frames to the video processor 106 properly, resulting in the frame rate converter 104 being able to receive image frames with the expected timestamps near the scheduled time instants (e.g., T1 and T3), the frame rate converter 104 may, corresponding to the time instant(s) (e.g., T2 or T4) requiring more output frame(s), employ the interpolation mode to create/insert/interpolate interpolated frame(s) using interpolation. When the video provider 12 fails to transmit image frame(s) to the video processor 106 properly, resulting in the frame rate converter 104 being unable to detect any image frame near the scheduled time instant(s) (e.g., T5), the frame rate converter 104 may, corresponding to the time instant(s) (e.g., T6-T8) requiring more output frame(s), automatically activate the extrapolation mode to create/insert/interpolate interpolated frame(s) using extrapolation. When the video provider 12 resumes normal transmission of image frames to the video processor 106, resulting in the frame rate converter 104 being able to receive an image frame with a certain timestamp near the scheduled time instant (e.g., T9), the frame rate converter 104 may, corresponding to the time instant(s) (e.g., T10) requiring more output frame(s), adopt the extrapolation mode to create/insert/interpolate interpolated frame(s) using extrapolation. When the frame rate converter 104 receives an image frame with the expected timestamp near the scheduled time instant (e.g., T11, T13, or T15), the frame rate converter 104 may, corresponding to the time instant(s) (e.g., T12, T14, or T16) requiring more output frame(s), adopt the interpolation mode to create/insert/interpolate interpolated frame(s) using interpolation.

As shown in FIG. 4 and FIG. 5, since the frame rate converter 104 uses a phase to generate an interpolated frame based on the current frame and the previous frame, a virtual position of the output frame may incrementally/decrementally follow a virtual position of the input frame, thereby improving output smoothness.

In one embodiment, in FIG. 3 and FIG. 5, the time interval between any two adjacent time instants T1, T3, T5, . . . . T15 is substantially equal/close to the reciprocal of the predetermined input frame rate (e.g., 60 Hz) of input frames, while the time interval between any two adjacent time instants T1, T2, T3, . . . . T16 is substantially equal/close to the reciprocal of the predetermined output frame rate (e.g., 120 Hz) of output frames.

In one embodiment, an image frame may correspond to, be added to, specify, or carry a timestamp. Timestamps are configured to indicate the timing relationship of visual contents of the image frames, to specify where the image frames are supposed to be located in the source video, or to indicate the time instants at which the processing of the image frames is supposed to start or end. In addition, a timestamp may be used to assess whether the input frame received at a certain time instant is the expected image frame that was supposed to be received at that time instant, or to assess whether the expected image that was supposed to be received is received at the expected time instant. For example, the frame rate converter 104 may use the timestamp (e.g., 86474321794) of an image frame received by the frame rate converter 104 at the time instant T13 to determine that the image frame is possibly the input frame G. That is, the image frame G is supposed to be located after an image frame (e.g., F) corresponding to a timestamp 86474301340 and before an image frame (e.g., H) corresponding to a timestamp 86474342875 in time domain. In other words, the timestamp (e.g., 86474321794) or the number (e.g., G) of an image frame represents the relative temporal relationship or chronological sequence.

In another aspect, a phase may be inferred inversely based on the virtual position of an output frame, and the virtual position may be set by the algorithm. For example, near the time instant T9 in FIG. 5, the video provider 12 inputs an image frame, and the frame rate converter 104 determines that the image frame is possibly the input frame C according to the timestamp of the image frame. Based on the premise of a constant speed of motion vectors, the virtual position of the input frame C is supposed to be 30. Then, the frame rate converter 104 determines the corresponding phase. To maintain smooth output, the virtual positions of output frames are supposed to progress at a constant speed as well. Since the virtual position of the output frame corresponding to the time instant T8 is 35, and the virtual positions of the output frames are supposed to follow the regular sequence of 0, 5, 10, 15, 20, . . . , 35, and 40, the virtual position of the output frame corresponding to the time instant T9 is 40. Accordingly, the phase corresponding to the time instant T9 may be derived to be 2 using the aforementioned equation x=a+(b−a)×p=(1−p)×a+p×b. An interpolated frame is then generated using extrapolation based on the previous frame B and the current frame C. Similarly, it may be deduced that the phase corresponding to the time instant T11 is 0.66 using the same approach.

Furthermore, if the video provider 12 provides the image frame E instead of the image frame C near the time instant T9, the same equation x=a+(b−a)×p=(1−p)×a+p×b may be used to derive the phase corresponding to the time instant T9 as 0.66. An interpolated frame is then generated using interpolation based on the previous frame B and the current frame E. If the video provider 12 provides the image frame D instead of the image frame C near the time instant T9, the phase corresponding to the time instant T9 may be inferred to be 1 according to the aforementioned equation x=a+(b−a)×p=(1−p)×a+p×b, and the image frame D is outputted as an interpolated frame correspondingly.

Please note that the entire interpolated frame (i.e., all of its image blocks) only correspond to one phase. However, the motion vector between a block in the current frame and its corresponding block in the previous frame may differ from the motion vector between another block in the current frame and its corresponding block in the previous frame. In other words, using the inversely derived phase, it is possible to calculate the positional information of each image block in an interpolated frame even when different image blocks correspond to different motion vectors, thereby improving output smoothness.

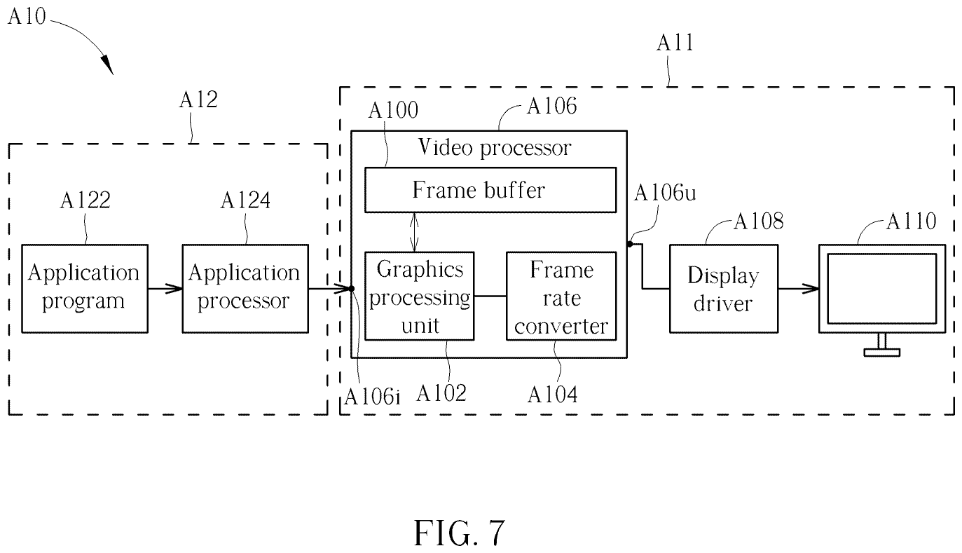

The electronic system may be adjusted according to various requirements. For example, the timestamp of an image frame may be generated by a certain component of the electronic system. For example, FIG. 7 is a schematic diagram of an electronic system A10 according to an embodiment of the present invention. Similar to FIG. 1, a display system A11 of the electronic system A10 includes a video processor A106, a display driver A108, and a display panel A110, which may be used to implement the video processor 106, the display driver 108, and the display panel 110 respectively. The video processor A106 may include an input terminal (circuit) A106i, an output terminal (circuit) A106u, a frame rate converter A104, a frame buffer A100, and a graphics processing unit (GPU) A102. The frame rate converter A104 may be used to implement the frame rate converter 104. A video provider A12 of the electronic system A10 may be used to implement the video provider 12.

The timestamp of an image frame may be generated in the video provider A12. The video provider A12 may include an application program A122 and an application processor A124. In one embodiment, the timestamp of an image frame is generated by the application processor A124; alternatively, the timestamp of an image frame is generated by the application program A122 and then passed through the application processor A124. Accordingly, the video processor A106 may obtain the timestamp of the input frame.

The timestamp of an image frame may be generated by the video processor A106. In one embodiment, the timestamp of an image frame is related to or is a function of a dequeue time instant at which the GPU A102 begins to access the frame buffer A100 for an input frame. Alternatively, the timestamp of an image frame is related to or is a function of a queue time instant at which the GPU A102 finishes using the frame buffer A100 for the input frame. A dequeue time instant may be the time instant at which the GPU A102 starts to output rendering result to the frame buffer A100. A queue time instant may be the time instant at which the GPU A102 finishes outputting the rendering result to the frame buffer A100, allowing the rendering result to be displayed on the display panel 110. The temporal difference between a dequeue time instant and its queue time instant is substantially equal to the time length for the GPU A102 to perform graphics rendering for the input frame. When the video processor A106 cannot figure out the timestamp of an image frame from the video provider A12, the video processor A106 may use a dequeue time instant (or a queue time instant) to generate a timestamp for the input frame by itself.

In one embodiment, based on the fact that the temporal difference between two adjacent dequeue time instants (or two adjacent queue time instants) is substantially equal/close to the reciprocal of the predetermined frame rate (e.g., 1/60 Hz=16.67 milliseconds) of input frames, the frame rate converter A104 may determine that no frame drop has occurred or that two input frames are consecutive. Under such conditions, the frame rate converter A104 may apply interpolation to generate an interpolated frame. Based on the fact that the temporal difference between two adjacent dequeue time instants (or two adjacent queue time instants) is substantially greater than or equal to twice the reciprocal of the predetermined frame rate (e.g., 33.33 milliseconds) of input frames, the frame rate converter 104 may determine that a frame drop has occurred or find the timing of the current frame on the axis of time. Under such conditions, the frame rate converter A104 may apply extrapolation to generate an interpolated frame.

In one embodiment, the frame rate converter A104 may choose interpolation or extrapolation to generate an interpolated frame based on whether the temporal difference between a queue time instant and its dequeue time instant exceeds a threshold value and whether the temporal difference between two adjacent queue time instants is substantially equal to the reciprocal of the predetermined frame rate of input frames. The frame rate converter A104 may choose interpolation or extrapolation to generate an interpolated frame based on whether the temporal difference between a queue time instant and its dequeue time instant is less than or equal to the threshold value and whether the temporal difference between two adjacent dequeue time instants is substantially equal to the reciprocal of the predetermined frame rate of input frames.

In one embodiment, the electronic system A10 (or 10) may be, for example, a mobile phone, a computer, or a television.

In one embodiment, the video provider A12 (or 12) may be, for example, a digital versatile disc (DVD) player or a video streaming service provider, capable of communicating with the display system A11 (or 11) via a wired or wireless network.

In one embodiment, the video processor A106 (or 106) may be configured to perform MEMC to generate interpolated frames. The video processor may be implemented as a stand-alone video processing integrated circuit (IC) separate from the video provider A12 (or 12); alternatively, the video processor may be integrated within the video processing IC. In one embodiment, the video processor may include a dedicated FRC IC; alternatively, the video processor may be a control IC embedded with a function of FRC. In other words, the frame rate converter A104 (or 104) may be regarded as a stand-alone FRC IC or an internal FRC circuit inside the control IC. In another embodiment, the video processor may include a GPU A102 and a stand-alone FRC IC; alternatively, the video processor may be a GPU with a built-in FRC circuit. In yet another embodiment, the video processor may include the frame buffer A100 for storing at least one input frame; alternatively, the frame buffer may be implemented as a separate component apart from the video processor.

In one embodiment, the frame rate converter A104 (or 104) may be configured to receive an image frame (i.e., an input frame) of a source video and simultaneously receive the previous frame stored in the frame buffer A100. Using the previous frame received from the frame buffer as a reference frame and based on the received input frame (i.e., the current frame), the frame rate converter may generate an interpolated frame with a frame rate that conforms to the output format of the display panel A110 (or 110). The frame rate converter may be implemented using a hardware circuit capable of performing specific function(s) and/or a software program of the display system A11 (or 11).

In one embodiment, the display driver A108 (or 108) may convert image data into data voltage signals, and drive the display panel A110 (or 110) to present image frame(s) through the data voltage signals. The display driver may include a timing controller, a source driver, a gate driver, and/or any other components suitable for driving the display panel.

In one embodiment, the display panel A110 (or 110) may be of any type, such as a liquid crystal display panel (LCD), a light emitting diode (LED) display, and a plasma display panel (PDP), but is not limited thereto.

In summary, the present invention may leverage interpolation to improve the frame rate. However, when any frame drop or delay occurs, it automatically switches to extrapolation to continue the generating of interpolated frame(s). Moreover, after image frame transmission is resumed, the present invention may dynamically switch MEMC to extrapolation or interpolation. Because of this dynamic switching capability between extrapolation and interpolation, the smoothness of image display may be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, for a video processor, comprising:
receiving a first input frame at a first time instant;
receiving a second input frame at a second time instant; and
creating an interpolated frame;
wherein when no input frame is received at a third time instant, the interpolated frame is generated using extrapolation according to the first and second input frames;
wherein when a third input frame is received at the third time instant, the interpolated frame is generated using interpolation according to the second and third input frames.

2. The image processing method of claim 1,
wherein there is a first time difference between the first and second time instants;
wherein there is a second time difference between the second and third time instants;
wherein when the third input frame is received at the third time instant and the first time difference is smaller than the second time difference, the interpolated frame is generated using extrapolation according to the second and third input frames.

3. The image processing method of claim 1, wherein when the third input frame is received at the third time instant and a second time difference is substantially equal to reciprocal of a predetermined input frame rate of the third input frame, the interpolated frame is generated using interpolation according to the second and third input frames.

4. The image processing method of claim 1, wherein when the third input frame is received at the third time instant and a second time difference is substantially greater than reciprocal of a predetermined input frame rate, the interpolated frame is generated using extrapolation according to the second and third input frames.

5. The image processing method of claim 1,
wherein based on a fact that a phase is less than 1, the interpolated frame is generated using interpolation; or
wherein based on a fact that the phase is greater than 1, the interpolated frame is generated using extrapolation.

6. The image processing method of claim 1,
wherein when no input frame is received at the third time instant, a phase corresponding to the third time instant is equal to a phase corresponding to a time instant prior to the third time instant plus a phase step;
wherein the phase step is equal to an input frame rate divided by an output frame rate.

7. The image processing method of claim 1,
wherein when the third input frame is received at the third time instant, a phase corresponding to the third time instant is equal to a phase corresponding to a time instant prior to the third time instant minus a phase step;
wherein the phase step is equal to an input frame rate divided by an output frame rate.

8. The image processing method of claim 1, wherein when the third input frame is received at the third time instant, a phase corresponding to the third time instant is adjusted according to a timestamp of the third input frame.

9. The image processing method of claim 1, wherein a timestamp of the third input frame is generated by an application processor or an application program.

10. The image processing method of claim 1,
wherein a timestamp of the third input frame is related to a dequeue time instant at which a graphics processing unit starts to use a frame buffer for the third input frame or a queue time instant at which the graphics processing unit ends to use the frame buffer for the third input frame;
wherein a temporal difference between the dequeue time instant and the queue time instant is substantially equal to a time length for the graphics processing unit to perform graphics-related processing for the third input frame.

11. A video processor, comprising:
an input terminal; and
an output terminal;
wherein the video processor is configured to:
receiving a first input frame at a first time instant;
receiving a second input frame at a second time instant; and
creating an interpolated frame;
wherein when no input frame is received at a third time instant, the interpolated frame is generated using extrapolation according to the first and second input frames;
wherein when a third input frame is received at the third time instant, the interpolated frame is generated using interpolation according to the second and third input frames.

12. The video processor of claim 11,
wherein there is a first time difference between the first and second time instants;
wherein there is a second time difference between the second and third time instants;
wherein when the third input frame is received at the third time instant and the first time difference is substantially smaller than the second time difference, the interpolated frame is generated using extrapolation according to the second and third input frames.

13. The video processor of claim 11, wherein when the third input frame is received at the third time instant and a second time difference is substantially equal to reciprocal of a predetermined input frame rate of the third input frame, the interpolated frame is generated using interpolation according to the second and third input frames.

14. The video processor of claim 11, wherein when the third input frame is received at the third time instant and a second time difference is substantially greater than reciprocal of a predetermined input frame rate, the interpolated frame is generated using extrapolation according to the second and third input frames.

15. The video processor of claim 11,
wherein based on a fact that a phase is less than 1, the interpolated frame is generated using interpolation; or
wherein based on a fact that the phase is greater than 1, the interpolated frame is generated using extrapolation.

16. The video processor of claim 11,
wherein when no input frame is received at the third time instant, a phase corresponding to the third time instant is equal to a phase corresponding to a time instant prior to the third time instant plus a phase step;
wherein the phase step is equal to an input frame rate divided by an output frame rate.

17. The video processor of claim 11,
wherein when the third input frame is received at the third time instant, a phase corresponding to the third time instant is equal to a phase corresponding to a time instant prior to the third time instant minus a phase step;
wherein the phase step is equal to an input frame rate divided by an output frame rate.

18. The video processor of claim 11, wherein when the third input frame is received at the third time instant, a phase corresponding to the third time instant is adjusted according to a timestamp of the third input frame.

19. The video processor of claim 11, wherein a timestamp of the third input frame is generated by an application processor or an application program.

20. The video processor of claim 11,
wherein a timestamp of the third input frame is related to a dequeue time instant at which a graphics processing unit starts to use a frame buffer for the third input frame or a queue time instant at which the graphics processing unit ends to use the frame buffer for the third input frame;
wherein a temporal difference between the dequeue time instant and the queue time instant is substantially equal to a time length for the graphics processing unit to perform graphics-related processing for the third input frame.
